(19) United States
(12) Patent Application Publication
(10) Pub. No.: US 2026/0290060 A1
(43) Pub. Date: Sep. 24, 2026

(54) CHARACTER-LEVEL TEXT DETECTION USING WEAKLY SUPERVISED LEARNING

(71) Applicant: INNOPEAK TECHNOLOGY, INC., Palo Alto, CA (US)

(72) Inventors: Xuewen YANG, Palo Alto, CA (US); Yuan LIN, Palo Alto, CA (US); Chiu Man HO, Palo Alto, CA (US)

(21) Appl. No.: 19/477,284

(22) PCT Filed: Jun. 30, 2023
(86) PCT No.: PCT/US2023/026797

§ 371 Date: Oct. 21, 2025

(51) Int. Cl. G06V 30/19; G06V 10/774; G06V 10/82; G06V 30/148

(52) U.S. Cl. CPC G06V 30/19173; G06V 10/774; G06V 10/82; G06V 30/153

(57) ABSTRACT

This application is directed to optical character recognition (OCR). An electronic device obtains an input image including textual content to be extracted from the input image and identifies a plurality of characters and a plurality of spacings separating the characters in the input image. The plurality of characters are grouped to two or more words based on the plurality of spacings.

### CROSS-REFERENCE OF RELATED APPLICATIONS

This application is a national stage of International Application No. PCT/US2023/026797, filed on Jun. 30, 2023, the disclosure of which is hereby incorporated by reference in its entirety.

### TECHNICAL FIELD

This application relates generally to optical character recognition (OCR) including, but not limited to, methods, systems, and non-transitory computer-readable media for converting textual content in an image to text (e.g., words and letters).

### BACKGROUND

Optical character recognition (OCR) techniques automatically extract electronic data from printed or written text in a scanned document or an image file. The electronic data is converted into a machine-readable form for further data processing (e.g., editing and searching). Examples of the printed or written text that can be processed by OCR include receipts, contracts, invoices, financial statements, and the like. If implemented efficiently, OCR improves information accessibility for users. Deep learning techniques have been applied to recognize textual content in the scanned document or image file. However, textual content cannot be recognized, e.g., when the textual content is curved, deformed, or extremely long. In some situations, the textual content in an image is hard to detect if it does not fit within a single predefined bounding box. Additionally, existing solutions cannot discern a finer granularity level than words in the textual content. It would be beneficial to develop systems and methods for recognizing text in a scanned document or image file in an accurate and efficient manner and with a fine granularity level.

### SUMMARY

Various embodiments of this application are directed to methods, systems, devices, non-transitory computer-readable media for recognizing text.

In one aspect, a text recognition method is implemented at an electronic device. The method includes obtaining an input image including textual content to be extracted from the input image. The method further includes identifying a plurality of characters in the input image and identifying a plurality of spacings separating the plurality of characters. The method further includes grouping the plurality of characters to two or more words based on the plurality of spacings.

In another aspect, some implementations include an electronic device that includes one or more processors and memory having instructions stored thereon, which when executed by the one or more processors cause the processors to perform the above method.

In yet another aspect, some implementations include a non-transitory computer-readable medium, having instructions stored thereon, which when executed by one or more processors cause the processors to perform the above method.

These illustrative embodiments and implementations are mentioned not to limit or define the disclosure, but to provide examples to aid understanding thereof. Additional embodiments are discussed in the Detailed Description, and further description is provided there.

### BRIEF DESCRIPTION OF THE DRAWINGS

For a better understanding of the various described implementations, reference should be made to the Detailed Description below, in conjunction with the following drawings in which like reference numerals refer to corresponding parts throughout the figures.

FIG. 1 is an example data processing environment having one or more servers communicatively coupled to one or more client devices, in accordance with some embodiments.

FIG. 2 is a block diagram illustrating an electronic device configured to process content data (e.g., image data), in accordance with some embodiments.

FIG. 3 is an example data processing environment for training and applying a neural network-based data processing model for processing visual and/or audio data, in accordance with some embodiments.

FIG. 4A is an example neural network applied to process content data in an NN-based data processing model, in accordance with some embodiments, and FIG. 4B is an example node in the neural network, in accordance with some embodiments.

FIG. 5A is an example pair of adjacent characters marked with a plurality of characteristics, in accordance with some embodiments.

FIG. 5B illustrates an example input image including textual content and a score map applied to identify the textual content in the input image, in accordance with some embodiments.

FIG. 6 is an example data processing model for converting an input image with textual content to character boxes or affinity boxes, in accordance with some embodiments.

FIG. 7A illustrates two characters that is separated by a character spacing in a word, in accordance with some embodiments.

FIG. 7B illustrates two characters that is separated by a word or sentence spacing of two words, in accordance with some embodiments.

FIG. 7C is a set of characters that are grouped to three words, in accordance with some embodiments.

FIG. 8 is a flow diagram of an example text recognition method, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of claims and the subject matter may be practiced without these specific details. For example, it will be apparent to one of ordinary skill in the art that the subject matter presented herein can be implemented on many types of electronic devices with digital video capabilities.

Various embodiments of this application are directed to methods, systems, devices, non-transitory computer-readable media for recognizing textual content in a scanned document or an image. The textual content includes a paragraph, a phrase, a word, or a letter on different granularity levels. Optical character recognition (OCR) technology is applied to automate data extraction from printed or written text (e.g., in a scanned document or image file) and convert the text into a machine-readable form to be used for data processing like editing or searching. OCR includes text detection in which bounding boxes of textual content are identified in the scanned document or image. OCR-processed digital files (e.g., scanned document, image) include receipts, contracts, invoices, financial statements and more. OCR includes text detection in which bounding boxes of textual content are identified in the OCR-processed digital files. In some embodiments associated with word-level text detection, the bounding boxes of textual content correspond to sentences or words and have variable sizes based on the textual content. Character locations are determined based on sentence or word locations Alternatively, in some embodiments associated with character-level text detection, the bounding boxes of textual content correspond to individual characters, and have fine-grained character locations. Word locations are determined by merging a subset of the character locations. In some user applications, character locations are applied to determine a character-by-character sequence. In some embodiments, a neural network is trained to predict character boxes, affinity boxes connecting adjacent characters, or both.

In some embodiments, a text recognition method is implemented at an electronic device. The method includes: obtaining an input image including textual content to be extracted from the input image; identifying a plurality of characters in the input image and identifying a plurality of spacings separating the plurality of characters; and grouping the plurality of characters to two or more words based on the plurality of spacings. In some embodiments, identifying the plurality of characters in the input image further includes applying a first machine learning model to identify a plurality of character boxes, each of the plurality of character boxes enclosing a respective one of the plurality of characters. Further, in some embodiments, applying the first machine learning model to identify the plurality of character boxes further includes applying the first machine learning model to generate a character score map having a two-dimensional (2D) array of character score elements. Each character score element corresponds to one or more respective character pixels of the input image and represents a probability of a center of a respective one of the plurality of characters located at the one or more respective character pixels. Applying the first machine learning model to identify the plurality of character boxes further includes, for each of the plurality of character boxes, identifying a respective character box that encloses only (1) a peak element having a peak probability value in the respective character box and (2) a set of neighboring elements immediately adjacent to the peak element and having probability values that are greater than a predefined portion of the peak probability value.

In some embodiments, each of the plurality of spacings corresponds to a respective affinity box connecting two centers of two immediately adjacent character boxes in a respective word. Further, in some embodiments, identifying the plurality of spacings further includes applying a second machine learning model to identify the respective affinity box corresponding to each of the plurality of spacings. Additionally, in some embodiments, applying the second machine learning model to identify the respective affinity box corresponding to each of the plurality of spacings further includes applying the second machine learning model to generate an affinity score map having a 2D array of affinity scores. Each affinity score corresponds to one or more respective spacing pixels of the input image and represents a probability of a center of a respective one of the plurality of spacings located at the one or more respective spacing pixels. Applying the second machine learning model to identify the respective affinity box corresponding to each of the plurality of spacings further includes identifying the respective affinity box corresponding, which encloses (1) a peak affinity score having a peak probability value in the respective affinity box and (2) the two centers of two immediately adjacent character boxes in a respective word.

More specifically, this application is directed to a text recognition method that localizes individual character boxes and links detected characters to text instances. An image having textual content is processed to identify bounding boxes and character locations in the textual content. In some embodiments, a neural network is trained to predict character boxes, affinity boxes connecting the characters, or both. As such, this text recognition method improves information accessibility for users.

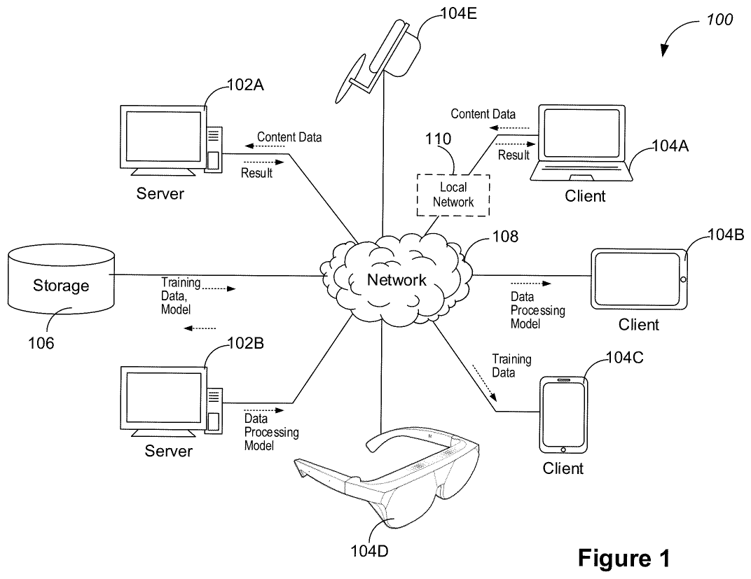

FIG. 1 is an example data processing environment 100 having one or more servers 102 communicatively coupled to one or more client devices 104, in accordance with some embodiments. The one or more client devices 104 may be, for example, desktop computers 104A, tablet computers 104B, mobile phones 104C, head-mounted display (HMD) (also called augmented reality (AR) glasses) 104D, or intelligent, multi-sensing, network-connected home devices (e.g., a surveillance camera 104E, a smart television device, a drone). Each client device 104 can collect data or user inputs, execute user applications, and present outputs on its user interface. The collected data or user inputs can be processed locally at the client device 104 and/or remotely by the server(s) 102. The one or more servers 102 provide system data (e.g., boot files, operating system images, and user applications) to the client devices 104, and in some embodiments, process the data and user inputs received from the client device(s) 104 when the user applications are executed on the client devices 104. In some embodiments, the data processing environment 100 further includes a storage 106 for storing data related to the servers 102, client devices 104, and applications executed on the client devices 104.

The one or more servers 102 are configured to enable real-time data communication with the client devices 104 that are remote from each other or from the one or more servers 102. Further, in some embodiments, the one or more servers 102 are configured to implement data processing tasks that cannot be or are preferably not completed locally by the client devices 104. For example, the client devices 104 include a game console (e.g., the HMD 104D) that executes an interactive online gaming application. The game console receives a user instruction and sends it to a game server 102 with user data. The game server 102 generates a stream of video data based on the user instruction and user data and providing the stream of video data for display on the game console and other client devices that are engaged in the same game session with the game console. In another example, the client devices 104 include a networked surveillance camera 104E and a mobile phone 104C. The networked surveillance camera 104E collects video data and streams the video data to a surveillance camera server 102 in real time. While the video data is optionally pre-processed on the surveillance camera 104E, the surveillance camera server 102 processes the video data to identify motion or audio events in the video data and share information of these events with the mobile phone 104C, thereby allowing a user of the mobile phone 104C to monitor the events occurring near the networked surveillance camera 104E in the real time and remotely.

The one or more servers 102, one or more client devices 104, and storage 106 are communicatively coupled to each other via one or more communication networks 108, which are the medium used to provide communications links between these devices and computers connected together within the data processing environment 100. The one or more communication networks 108 may include connections, such as wire, wireless communication links, or fiber optic cables. Examples of the one or more communication networks 108 include local area networks (LAN), wide area networks (WAN) such as the Internet, or a combination thereof. The one or more communication networks 108 are, optionally, implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VOIP), Wi-MAX, or any other suitable communication protocol. A connection to the one or more communication networks 108 may be established either directly (e.g., using 3G/4G connectivity to a wireless carrier), or through a network interface 110 (e.g., a router, switch, gateway, hub, or an intelligent, dedicated whole-home control node), or through any combination thereof. As such, the one or more communication networks 108 can represent the Internet of a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages.

In some embodiments, deep learning techniques are applied in the data processing environment 100 to process content data (e.g., video data, visual data, audio data) obtained by an application executed at a client device 104 to identify information contained in the content data, match the content data with other data, categorize the content data, or synthesize related content data. In these deep learning techniques, data processing models are created based on one or more neural networks to process the content data. These data processing models are trained with training data before they are applied to process the content data. Subsequently to model training, the client device 104 obtains the content data (e.g., captures video data via an internal camera) and processes the content data using the data processing models locally.

In some embodiments, both model training and data processing are implemented locally at each individual client device 104. The client device 104 obtains the training data from the one or more servers 102 or storage 106 and applies the training data to train the data processing models. Alternatively, in some embodiments, both model training and data processing are implemented remotely at a server 102 (e.g., the server 102A) associated with a client device 104. The server 102A obtains the training data from itself, another server 102 or the storage 106 applies the training data to train the data processing models. The client device 104 obtains the content data, sends the content data to the server 102A (e.g., in an application) for data processing using the trained data processing models, receives data processing results (e.g., recognized hand gestures) from the server 102A, presents the results on a user interface (e.g., associated with the application), renders virtual objects in a field of view based on the poses, or implements some other functions based on the results. The client device 104 itself implements no or little data processing on the content data prior to sending them to the server 102A. Additionally, in some embodiments, data processing is implemented locally at a client device 104, while model training is implemented remotely at a server 102 (e.g., the server 102B) associated with the client device 104. The server 102B obtains the training data from itself, another server 102 or the storage 106 and applies the training data to train the data processing models. The trained data processing models are optionally stored in the server 102B or storage 106. The client device 104 imports the trained data processing models from the server 102B or storage 106, processes the content data using the data processing models, and generates data processing results to be presented on a user interface or used to initiate some functions (e.g., rendering virtual objects based on device poses) locally.

In some embodiments, a pair of AR glasses 104D (also called an HMD) are communicatively coupled in the data processing environment 100. The HMD 104D includes a camera, a microphone, a speaker, one or more inertial sensors (e.g., gyroscope, accelerometer), and a display. The camera and microphone are configured to capture video and audio data from a scene of the HMD 104D, while the one or more inertial sensors are configured to capture inertial sensor data. In some situations, the camera captures hand gestures of a user wearing the HMD 104D, and recognizes the hand gestures locally and in real time using a two-stage hand gesture recognition model. In some situations, the microphone records ambient sound, including user's voice commands. In some situations, both video or static visual data captured by the camera and the inertial sensor data measured by the one or more inertial sensors are applied to determine and predict device poses. The video, static image, audio, or inertial sensor data captured by the HMD 104D is processed by the HMD 104D, server(s) 102, or both to recognize the device poses. Optionally, deep learning techniques are applied by the server(s) 102 and HMD 104D jointly to recognize and predict the device poses. The device poses are used to control the HMD 104D itself or interact with an application (e.g., a gaming application) executed by the HMD 104D. In some embodiments, the display of the HMD 104D displays a user interface, and the recognized or predicted device poses are used to render or interact with user selectable display items (e.g., an avatar) on the user interface.

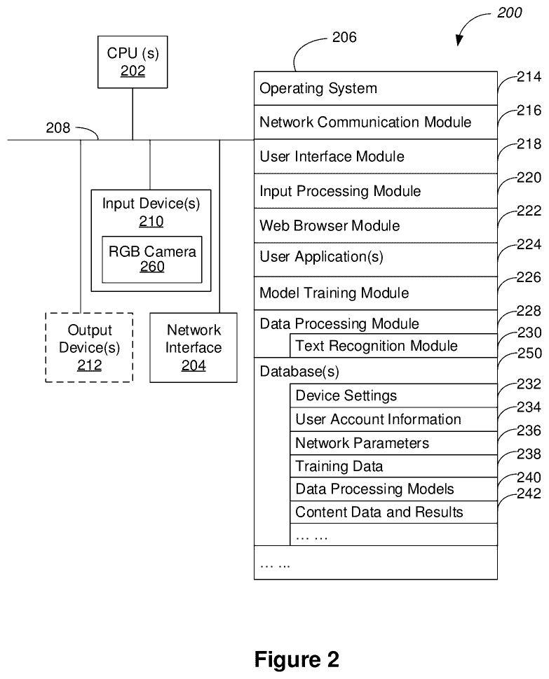

FIG. 2 is a block diagram illustrating an electronic system 200 configured to process content data (e.g., image data), in accordance with some embodiments. The electronic system 200 includes a server 102, a client device 104 (e.g., HMD 104D in FIG. 1), a storage 106, or a combination thereof. The electronic system 200, typically, includes one or more processing units (CPUs) 202, one or more network interfaces 204, memory 206, and one or more communication buses 208 for interconnecting these components (sometimes called a chipset). The electronic system 200 includes one or more input devices 210 that facilitate user input, such as a keyboard, a mouse, a voice-command input unit or microphone, a touch screen display, a touch-sensitive input pad, a gesture capturing camera, or other input buttons or controls. Furthermore, in some embodiments, the client device 104 of the electronic system 200 uses a microphone for voice recognition or a camera 260 for gesture recognition to supplement or replace the keyboard. In some embodiments, the client device 104 includes one or more optical cameras 260 (e.g., an RGB camera), scanners, or photo sensor units for capturing images, for example, of graphic serial codes printed on the electronic devices. The electronic system 200 also includes one or more output devices 212 that enable presentation of user interfaces and display content, including one or more speakers and/or one or more visual displays. Optionally, the client device 104 includes a location detection device, such as a GPS (global positioning system) or other geo-location receiver, for determining the location of the client device 104.

Memory 206 includes high-speed random access memory, such as DRAM, SRAM, DDR RAM, or other random access solid state memory devices; and, optionally, includes non-volatile memory, such as one or more magnetic disk storage devices, one or more optical disk storage devices, one or more flash memory devices, or one or more other non-volatile solid state storage devices. Memory 206, optionally, includes one or more storage devices remotely located from one or more processing units 202. Memory 206, or alternatively the non-volatile memory within memory 206, includes a non-transitory computer readable storage medium. In some embodiments, memory 206, or the non-transitory computer readable storage medium of memory 206, stores the following programs, modules, and data structures, or a subset or superset thereof:
Operating system 214 including procedures for handling various basic system services and for performing hardware dependent tasks;
Network communication module 216 for connecting each server 102 or client device 104 to other devices (e.g., server 102, client device 104, or storage 106) via one or more network interfaces 204 (wired or wireless) and one or more communication networks 108, such as the Internet, other wide area networks, local area networks, metropolitan area networks, and so on;
User interface module 218 for enabling presentation of information (e.g., a graphical user interface for application(s) 224, widgets, websites and web pages thereof, and/or games, audio and/or video content, text, etc.) at each client device 104 via one or more output devices 212 (e.g., displays, speakers, etc.);
Input processing module 220 for detecting one or more user inputs or interactions from one of the one or more input devices 210 and interpreting the detected input or interaction;
Web browser module 222 for navigating, requesting (e.g., via HTTP), and displaying websites and web pages thereof, including a web interface for logging into a user account associated with a client device 104 or another electronic device, controlling the client or electronic device if associated with the user account, and editing and reviewing settings and data that are associated with the user account;
One or more user applications 224 for execution by the electronic system 200 (e.g., games, social network applications, smart home applications, and/or other web or non-web based applications for controlling another electronic device and reviewing data captured by such devices), where in some embodiments, the user application(s) 224 include an OCR application for recognizing textual content in an image;
Model training module 226 for receiving training data and establishing a data processing model for processing content data (e.g., video, image, audio, or textual data) to be collected or obtained by a client device 104;
Data processing module 228 for processing content data using data processing models 240, thereby identifying information contained in the content data, matching the content data with other data, categorizing the content data, or synthesizing related content data, where in some embodiments, the data processing module 228 includes a text recognition module 230, and the text recognition module 230 is associated with one of the user applications 224 (e.g., an OCR application) and configured to recognize characters and words in textual content of an image;
One or more databases 250 for storing at least data including one or more of:
   Device settings 232 including common device settings (e.g., service tier, device model, storage capacity, processing capabilities, communication capabilities, etc.) of the one or more servers 102 or client devices 104;
   User account information 234 for the one or more user applications 224, e.g., user names, security questions, account history data, user preferences, and predefined account settings;
   Network parameters 236 for the one or more communication networks 108, e.g., IP address, subnet mask, default gateway, DNS server and host name;
   Training data 238 for training one or more data processing models 240;
   Data processing model(s) 240 for processing content data (e.g., video, image, audio, or textual data) using machine learning techniques, where the data processing models 240 includes a machine learning model for recognizing character boxes, affinity boxes connecting the character boxes, or both in textual content of an input image; and
   Content data and results 242 that are obtained by and outputted to the client device 104 of the electronic system 200, respectively, where the content data is processed by the data processing models 240 locally at the client device 104 or remotely at the server 102 to provide the associated results (e.g., characters recognized in textual content of an image).

Optionally, the one or more databases 250 are stored in one of the server 102, client device 104, and storage 106 of the electronic system 200. Optionally, the one or more databases 250 are distributed in more than one of the server 102, client device 104, and storage 106 of the electronic system 200. In some embodiments, more than one copy of the above data is stored at distinct devices, e.g., two copies of the data processing models 240 are stored at the server 102 and storage 106, respectively.

Each of the above identified elements may be stored in one or more of the previously mentioned memory devices, and corresponds to a set of instructions for performing a function described above. The above identified modules or programs (i.e., sets of instructions) need not be implemented as separate software programs, procedures, modules or data structures, and thus various subsets of these modules may be combined or otherwise re-arranged in various embodiments. In some embodiments, memory 206, optionally, stores a subset of the modules and data structures identified above. Furthermore, memory 206, optionally, stores additional modules and data structures not described above.

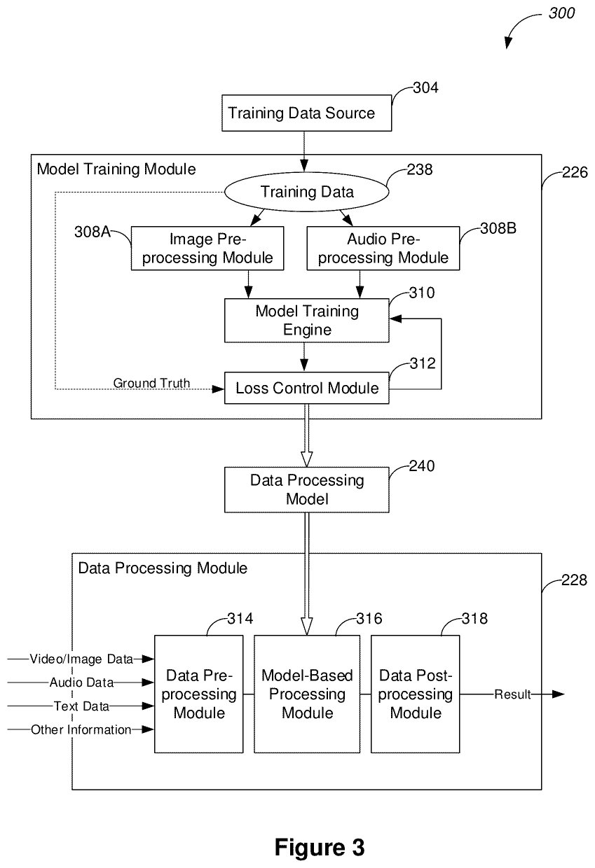

FIG. 3 is another example of a data processing system 300 for training and applying a neural network based (NN-based) data processing model 240 (FIG. 2) for processing content data (e.g., video, image, audio, or textual data), in accordance with some embodiments. The data processing system 300 includes a model training module 226 (FIG. 2) for establishing the data processing model 240 and a data processing module 228 (FIG. 2) for processing the content data using the data processing model 240. In some embodiments, both of the model training module 226 and the data processing module 228 are located on a client device 104 of the data processing system 300, while a training data source 304 distinct from the client device 104 provides training data 238 (FIG. 2) to the client device 104. The training data source 304 is optionally a server 102 or storage 106. Alternatively, in some embodiments, the model training module 226 and the data processing module 228 are both located on a server 102 of the data processing system 300. The training data source 304 providing the training data 238 is optionally the server 102 itself, another server 102, or the storage 106. Additionally, in some embodiments, the model training module 226 and the data processing module 228 are separately located on a server 102 and client device 104, and the server 102 provides the trained data processing model 240 to the client device 104.

The model training module 226 includes one or more data pre-processing modules 308, a model training engine 310, and a loss control module 312. The data processing model 240 is trained according to the type of content data to be processed. The training data 238 is consistent with the type of the content data, so is a data pre-processing module 308 applied to process the training data 238 consistent with the type of the content data. For example, an image pre-processing module 308A is configured to process image training data 238 to a predefined image format, e.g., extract a region of interest (ROI) in each training image, and crop each training image to a predefined image size. Alternatively, an audio pre-processing module 308B is configured to process audio training data 238 to a predefined audio format, e.g., converting each training sequence to a frequency domain using a Fourier transform. The model training engine 310 receives pre-processed training data provided by the data pre-processing modules 308, further processes the pre-processed training data using an existing data processing model 240, and generates an output from each training data item. During this course, the loss control module 312 can monitor a loss function comparing the output associated with the respective training data item and a ground truth of the respective training data item. The model training engine 310 modifies the data processing model 240 to reduce the loss function, until the loss function satisfies a loss criterion (e.g., a comparison result of the loss function is minimized or reduced below a loss threshold). The modified data processing model 240 is provided to the data processing module 228 to process the content data.

In some embodiments, the model training module 226 offers supervised learning in which the training data is entirely labelled and includes a desired output for each training data item (also called the ground truth in some situations). Conversely, in some embodiments, the model training module 226 offers unsupervised learning in which the training data are not labelled. The model training module 226 is configured to identify previously undetected patterns in the training data without pre-existing labels and with no or little human supervision. Additionally, in some embodiments, the model training module 226 offers partially supervised learning in which the training data are partially labelled.

The data processing module 228 includes a data pre-processing module 314, a model-based processing module 316, and a data post-processing module 318. The data pre-processing modules 314 pre-processes the content data based on the type of the content data. Functions of the data pre-processing modules 314 are consistent with those of the pre-processing modules 308 and covert the content data to a predefined content format that is acceptable by inputs of the model-based processing module 316. Examples of the content data include one or more of the following: video, image, audio, textual, and other types of data. For example, each image is pre-processed to extract an ROI or cropped to a predefined image size, and an audio clip is pre-processed to convert to a frequency domain using a Fourier transform. In some situations, the content data includes two or more types, e.g., video data and textual data. The model-based processing module 316 applies the trained data processing model 240 provided by the model training module 226 to process the pre-processed content data. The model-based processing module 316 can also monitor an error indicator to determine whether the content data has been properly processed in the data processing module 228. In some embodiments, the processed content data is further processed by the data post-processing module 318 to present the processed content data in a preferred format or to provide other related information that can be derived from the processed content data.

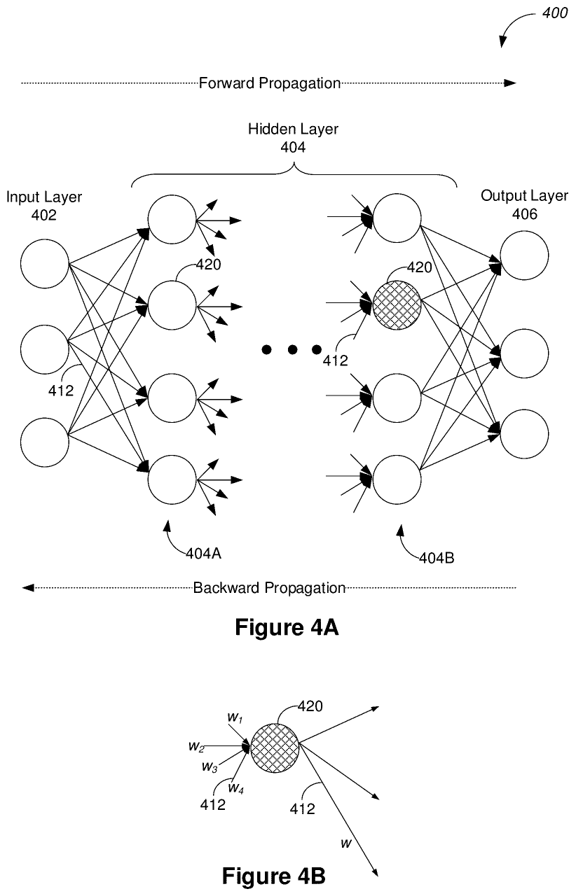

FIG. 4A is an exemplary neural network (NN) 400 applied to process content data in an NN-based data processing model 240, in accordance with some embodiments, and FIG. 4B is an example of a node 420 in the neural network (NN) 400, in accordance with some embodiments. The data processing model 240 is established based on the neural network 400. A corresponding model-based processing module 316 applies the data processing model 240 including the neural network 400 to process content data that has been converted to a predefined content format. The neural network 400 includes a collection of nodes 420 that are connected by links 412. Each node 420 receives one or more node inputs and applies a propagation function to generate a node output from the node input(s). As the node output is provided via one or more links 412 to one or more other nodes 420, a weight w associated with each link 412 is applied to the node output. Likewise, the node input(s) can be combined based on corresponding weights w₁, w₂, w₃, and w₄ according to the propagation function. For example, the propagation function is a product of a non-linear activation function and a linear weighted combination of the node input(s).

The collection of nodes 420 is organized into one or more layers in the neural network 400. Optionally, the layer(s) may include a single layer acting as both an input layer and an output layer. Optionally, the layer(s) may include an input layer 402 for receiving inputs, an output layer 406 for providing outputs, and zero or more hidden layers 404 (e.g., 404A and 404B) between the input and output layers 402 and 406. A deep neural network has more than one hidden layer 404 between the input and output layers 402 and 406. In the neural network 400, each layer is only connected with its immediately preceding and/or immediately following layer. In some embodiments, a layer 402 or 404B is a fully connected layer because each node 420 in the layer 402 or 404B is connected to every node 420 in its immediately following layer. In some embodiments, one of the hidden layers 404 includes two or more nodes that are connected to the same node in its immediately following layer for down sampling or pooling the nodes 420 between these two layers. Particularly, max pooling uses a maximum value of the two or more nodes in the layer 404B for generating the node of the immediately following layer 406 connected to the two or more nodes.

In some embodiments, a convolutional neural network (CNN) is applied in a data processing model 240 to process content data (particularly, video and image data). The CNN employs convolution operations and belongs to a class of deep neural networks 400, i.e., a feedforward neural network that only moves data forward from the input layer 402 through the hidden layers to the output layer 406. The hidden layer(s) of the CNN can be convolutional layers convolving with multiplication or dot product. Each node in a convolutional layer receives inputs from a receptive area associated with a previous layer (e.g., five nodes), and the receptive area is smaller than the entire previous layer and may vary based on a location of the convolution layer in the convolutional neural network. Video or image data is pre-processed to a predefined video/image format corresponding to the inputs of the CNN. The pre-processed video or image data is abstracted by each layer of the CNN to a respective feature map. By these means, video and image data can be processed by the CNN for video and image recognition, classification, analysis, imprinting, or synthesis.

Alternatively and additionally, in some embodiments, a recurrent neural network (RNN) is applied in the data processing model 240 to process content data (particularly, textual and audio data). Nodes in successive layers of the RNN follow a temporal sequence, such that the RNN exhibits a temporal dynamic behavior. For example, each node 420 of the RNN has a time-varying real-valued activation. Examples of the RNN include, but are not limited to, a long short-term memory (LSTM) network, a fully recurrent network, an Elman network, a Jordan network, a Hopfield network, a bidirectional associative memory (BAM network), an echo state network, an independently RNN (IndRNN), a recursive neural network, and a neural history compressor. In some embodiments, the RNN can be used for handwriting or speech recognition. It is noted that in some embodiments, two or more types of content data are processed by the data processing module 228, and two or more types of neural networks (e.g., CNN, RNN, residual neural network (ResNet)) are applied to process the content data jointly.

The training process is a process for calibrating all of the weights wi for each layer of the learning model using a training data set which is provided in the input layer 402. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured, and the weights are adjusted accordingly to decrease the error. The activation function is optionally linear, rectified linear unit, sigmoid, hyperbolic tangent, or of other types. In some embodiments, a network bias term b is added to the sum of the weighted outputs from the previous layer before the activation function is applied. The network bias b provides a perturbation that helps the NN 400 avoid over fitting the training data. The result of the training includes the network bias parameter b for each layer.

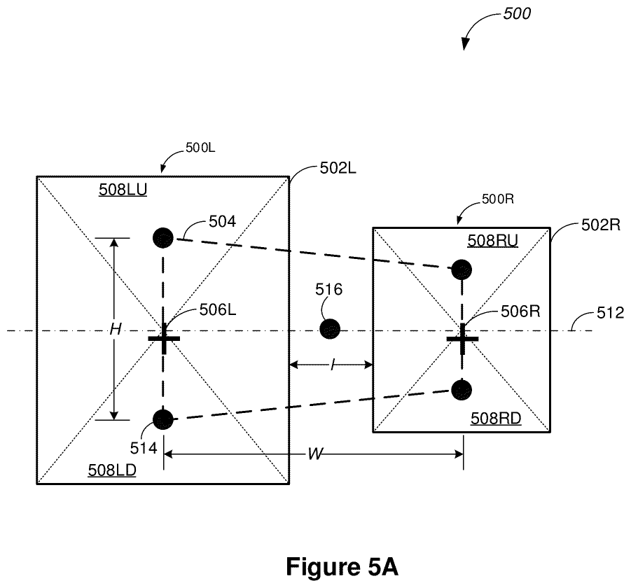

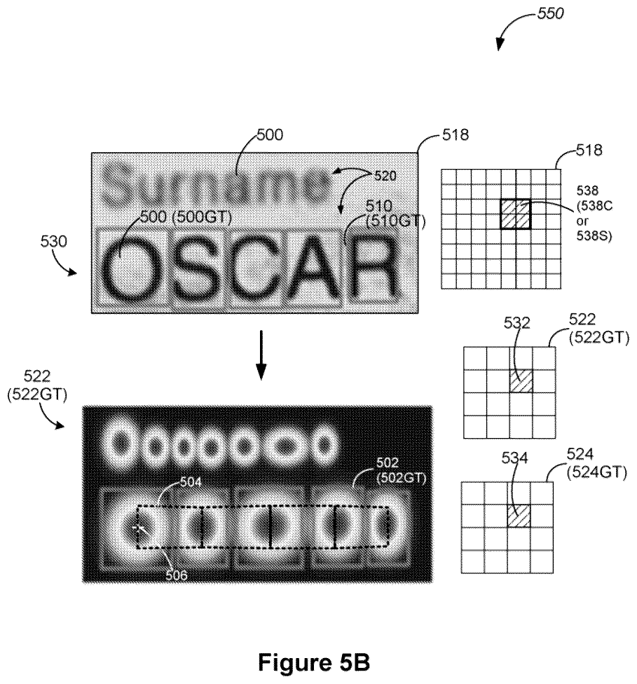

FIG. 5A is an example pair of adjacent characters 500 marked with a plurality of characteristics, in accordance with some embodiments. The pair of characters 500 includes two basic language units that are placed immediately adjacent to each other and separated by a character spacing 510. In an example, the pair of characters 500 includes two immediately adjacent characters 500L and 500R in a word in English. In another example, the pair of characters 500 includes two immediately adjacent characters 500L and 500R in a sentence in Chinese. Each character 500L or 500R is defined by a respective character box 502L or 502R, and has a respective center 506L or 506R. In some embodiments, a respective position of each character 500L or 500R is represented by a position of the respective center 506L or 506R. A straight line 512 passes both of the centers 506L and 506R. In some embodiments, each of the character boxes 502L and 502R is symmetric with respect to the straight line 512.

For each character box 502L or 502R, the respective character box 502L or 502R is divided to four regions. In some embodiments, each region includes a triangle defined by the respective center 506L or 506R and a corresponding edge of four edges of the respective character box 502L or 502R. The character box 502L includes a first region 508LU and a second region 508LD that are separated by the straight line 512 and opposite to each other. The character box 502R includes a third region 508RU and a fourth region 508RD that are also separated by the straight line 512 and opposite to each other. Centers 514 of the regions 508LU, 508LD, 508RU, and 508RD are connected to form a quadrilateral box 504 (also called affinity box 504) having a width W and a height H. The width W of the quadrilateral shape 504 is determined based on widths and a separation l of the character boxes 502L and 502R, and the height H of the quadrilateral box 504 is determined based on a greater one of heights of the character boxes 502L and 502R. The separation I of the character boxes 502L and 502R has a center 516 located on the straight line 512.

FIG. 5B illustrates an example input image 518 including textual content 520 and a score map 522 applied to identify the textual content 520 in the input image 518, in accordance with some embodiments. The textual content 520 is extracted, e.g., by a data processing model 240, from the input image 518. The textual content 520 includes a plurality of characters 500 and a plurality of spacings 510 separating the plurality of characters 500. In some embodiments, the data processing model 240 generates a character score map 522 corresponding to the plurality of characters 500, and the plurality of character boxes 502 enclosing the plurality of characters 500 is determined based on the character score map 522. In some embodiments, the data processing model 240 generates an affinity score map 524 corresponding to the plurality of spacings 510, and affinity boxes 504 corresponding to the plurality of spacings 510 are determined based on the affinity score map 524. The plurality of characters 500 is further grouped to two or more words 530 based on the plurality of spacings 510. Referring to FIG. 5B, the input image 518 has two words (e.g., “Surname”, “OSCAR”) on two rows, and two target words “Surname” and “OSCAR” are recognized based on the characters 500 or spacings 510 determined based on the score map 522 or 524.

In some embodiments, the character score map 522 having a 2D array of character score elements 532. Each character score element 532 corresponds to one or more respective character pixels 538C of the input image 518 and represents a probability of a center 506 of a respective one of the plurality of characters 500 located at the one or more respective character pixels 538C. For each of the plurality of character boxes 502, a respective character box 502 is identified to enclose only (1) a peak element having a peak probability value in the respective character box 502 and (2) a set of neighboring elements adjacent to the peak element and having probability values that are greater than a predefined portion of the peak probability value. For example, the probability values of the set of neighboring elements are greater than a standard deviation o from the peak probability value.

In some embodiments, the character score map 522 has a resolution that is identical to that of the input image 518. Each character score element 532 corresponds to a single character pixel 538C of the input image 518. Alternatively, in some embodiments, the character score map 522 has a lower resolution than that of the portion of the input image 518 corresponding to the target word (e.g., “OSCAR”). Each character score element 532 corresponds to a set of character pixels 538C (e.g., 2×2 or 3×3 character pixels 538C) of the input image 518. Seven character boxes 502 (not shown) and five character boxes 502 (shown) are identified on two separate rows of the character score map 522. Each character box 502 has a peak element located substantially at the center 506 of the respective character box 502, and edges of the respective box 502 are determined based on the predefined portion. In an example, the predefined portion is equal to 0.5. The probability value of the center 506 of the respective character box 502 drops from the peak probability of the peak element to the probability values on the edges of the respective character box 502 by 50%.

In some embodiments, each of the plurality of spacings 510 corresponds to a respective affinity box 504 connecting two centers 506 (e.g., 506L and 506R) of two immediately adjacent character boxes 502 in a respective word 530. Each affinity box 504 corresponds to a single spacing 510 between two immediately adjacent characters 500. In some embodiments, each affinity box 504 is determined based on two character boxes 502L and 502R of the two immediately adjacent characters 500L and 500R. In some embodiments, the affinity boxes 504 are determined based on the affinity score map 524 (simplified), which has a 2D array of affinity score elements 534. Each affinity score element 534 corresponds to one or more respective spacing pixels 538S of the input image 518 and represents a probability of a center 516 of a respective one of the plurality of spacings 510 located at the one or more respective spacing pixels 538S. Each respective affinity box 504 encloses (1) a peak affinity score having a peak probability value in the respective affinity box 504 and (2) the two centers 506 of two immediately adjacent character boxes 502 in a respective word 530.

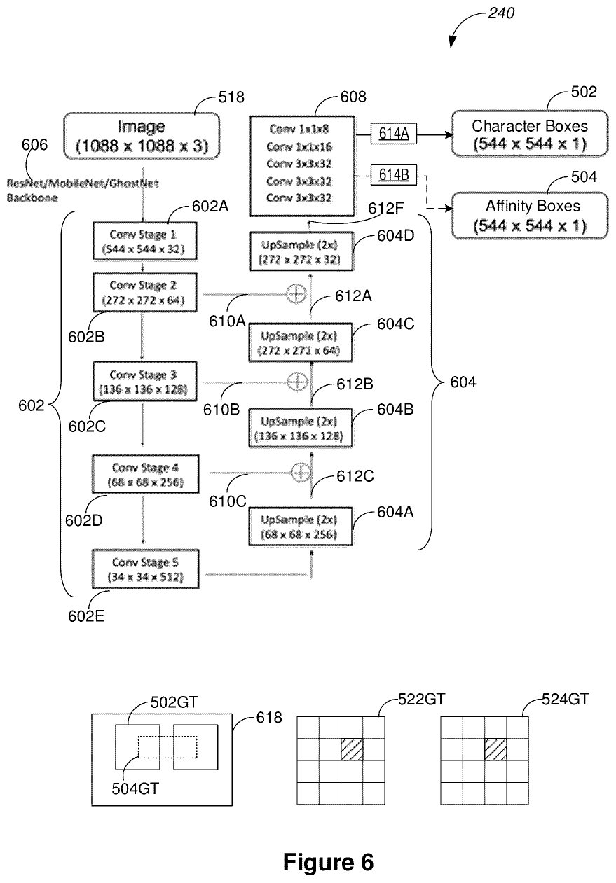

In some embodiments, the input image 518 is applied as a training image (e.g., 618 in FIG. 6) to train a data processing model 240, and a ground truth label is generated for the input image 518 to include a plurality of ground truth character boxes 502GT. Each ground truth character box 502GT closely encloses a respective distinct ground truth character 500GT in the input image 518 used for training. The data processing model 240 is trained based on the input image 518 and the plurality of ground truth character boxes 502GT labeled on the input image 518. Further, in some embodiments, a 2D Gaussian map is generated and includes a plurality of 2D Gaussian map regions corresponding to the plurality of ground truth characters 500GT. Each 2D Gaussian map region corresponds to a characteristic length in which a peak probability value drops by a characteristic portion (e.g., by 50%, by a standard deviation σ, by 1.5σ, by 2σ). Specifically, in an example, a center 506 of the respective ground truth character box 502GT is associated with the peak probability value of the respective 2D Gaussian map region, and a middle point of an edge of the respective ground truth character box 502GT is associated with the characteristic portion of the peak probability value of the respective 2D Gaussian map region. In accordance with a 2D Gaussian distribution, probability values in respective 2D Gaussian map region drop along a width direction and a height direction, from the center 506 to the middle point of the edge of the respective ground truth character box 502GT. The 2D Gaussian map is applied as a ground truth character score map 522GT.

In some embodiments, ground truth affinity boxes are generated based on the ground truth character boxes 502GT, so are centers of the corresponding ground truth spacings 510GT separating the ground truth characters 500GT identified. Another 2D Gaussian map is generated based on the ground truth affinity boxes and the centers of the corresponding spacings 510GT, and applied as a ground truth affinity score map 524GT.

During training, each of a plurality of training character boxes 502 is identified for an input image 518. The data processing model 240 is applied to generate the character score map 522 (e.g., a feature map 614A in FIG. 6), which is compared to the ground truth character score map 522GT. In some embodiments, the data processing model 240 is applied to generate the affinity score map 524 (e.g., a feature map 614B in FIG. 6), which is compared to the ground truth affinity score map 524GT. By these means, the plurality of training character boxes 502 and the plurality of ground truth character boxes 502GT are compared. A loss function L is generated as a result of comparison, and the data processing model 240 is dynamically modified based on the loss function L.

Stated another way, in some embodiments, the ground truth label of each training image 518 is generated to include one or more of: the character score map 522GT, the affinity score map 524GT, and associated character boxes 502GT. Each score element 532 of the character score map 522GT represents the probability that the corresponding one or more pixels 538C are the center of the respective character 500. Each affinity score element 534 of the affinity score map 524GT represents the probability that the pixel is the center of the spacing 510 between two immediately adjacent characters 500. A probability distribution is simulated using Gaussian heatmaps having values between 0 and 1. Each training image includes ground truth character boxes 502GT. In some embodiments, the ground truth character score map 522GT is approximated and generated by one or more of: (1) preparing a 2D Gaussian map; (2) implementing a perspective transform between a respective Gaussian map region and each character box; (3) warping the respective 2D Gaussian map region to each character box 502. During training, the character boxes 502 of the characters 500 are determined to match the ground truth score map 522GT as shown in FIG. 5B.

In some embodiments, the affinity boxes 504 and associated affinity score map 524 are not outputted directly by the data processing model 228, and instead, is determined based on the character boxes 502 and associated character score map 522 determined by the data processing model 228. The centers 514 of top and bottom triangles of two immediately adjacent character boxes 502 are connected to form the affinity boxes 504.

FIG. 6 is an example data processing model 240 for converting an input image 518 with textual content 520 to character boxes 502 or affinity boxes 504, in accordance with some embodiments. The data processing model 240 is associated with feature extraction, ground truth label generation, and detection model training. For feature extraction, the data processing model 240 receives the input image 518 and identifies from the textual content 520 a plurality of character boxes 502, a plurality of affinity boxes 504, or both. Each of the plurality of character boxes 502 encloses a respective one of a plurality of characters 500, and each of the plurality of affinity boxes 504 corresponds to a spacing 510 between two respective immediately adjacent characters 500. In some embodiments, the plurality of character boxes 502 or the plurality of affinity boxes 504 is applied to determine character locations of the plurality of characters 500 of the textual content 520 in the input image 518 and merge the character locations to get one or more word-level bounding boxes.

In some embodiments, the data processing model 240 includes a first machine learning model configured to identify the plurality of character boxes 502. The plurality of spacings 510 separating the plurality of characters 500 are optionally determined based on the plurality of character boxes 502. Alternatively, in some embodiments, the same first machine learning model is configured to identify the respective affinity boxes 504 corresponding to the plurality of spacings 510. Alternatively and additionally, in some embodiments, the data processing model 240 includes a second machine learning model configured to identify a respective affinity boxes 504 corresponding to the plurality of spacings 510.

In some embodiments, the data processing model 240 includes an encoding network 602 and a decoding network 604 coupled to the encoding network 602. The encoding network 602 includes a series of down-sampling stages (e.g., 602A, 602B, 602C, 602D, and 602E), and the decoding network 604 includes a series of up-sampling stages (e.g., 604A, 604B, 604C, and 604D). The down-sampling and up-sampling stages are arranged according to a scaling factor (e.g., 2). For example, two successive down-sampling stages include a first down-sampling stage and a second down-sampling stage that immediately follows the first down-sampling stage. A feature map outputted by the second down-sampling stage has a resolution that is scaled down by the scaling factor from a feature map outputted by the first down-sampling stage, and has a number of channels that is scaled up by the scaling factor from the feature map outputted by the first down-sampling stage. Two successive up-sampling stages include a first up-sampling stage and a second up-sampling stage that immediately follows the first up-sampling stage. A feature map outputted by the second up-sampling stage has a resolution that is scaled up by a feature map outputted by the scaling factor from the first up-sampling stage, and has a number of channels that is scaled down by the scaling factor from the feature map outputted by the first up-sampling stage. In some embodiments, the encoding network 602 and the decoding network 604 form a U-net without a bottleneck network. In some embodiments, the encoding network 602 and the decoding network 604 form a U-net with a bottleneck network (not shown). Further, in some embodiments, the data processing model 240 further includes an input feature extractor 606 coupled to a first down-sampling stage 602A and an output network 608 coupled to a last up-sampling stage 604D. In some embodiments, the input feature extractor 606 is one of: ResNet, MobileNet, GhostNet, and Backbone. In some embodiments, the output network 608 includes a plurality of CNN layers.

Additionally, in some embodiments, each of a subset of down-sampling stages 602B, 602C, and 602D provides an intermediate down-sampled feature 610A, 610B, or 610C to the decoding network 604 via a respective skip connection. The intermediate down-sampled feature 610A, 610B, or 610C is combined with an intermediate up-sampled feature 612A, 612B, or 612C (e.g., on an element-by-element basis, by concatenation) to generate a combined intermediate feature, which is up-sampled by a respective up-sampling stage 604D, 604C, or 604B, respectively.

In an example, the input image 518 includes an RGB image having three color channels and a resolution of 1088×1088 pixels. Deep convolutional neural networks (CNNs) are applied to extract feature maps of the input image 518. Each CNN-based down-sampling stage outputs intermediate feature maps of different resolutions. The convolutional stages 602A, 602B, 602C, 602D, and 602E generate feature maps having 32, 64, 128, 256, and 512 channels and resolutions of 544×544, 272×272, 136×136, 68×68, 34×34 elements, respectively. The decoding network 604 has a U-net structure to aggregate low-level features. The decoding network 604 includes four up-sampling stages 604A, 604B, 604C, and 604D. Each of the up-sampling stages 604A-604C generates an intermediate up-sampled feature 612C, 612B, or 612A, which is scaled up by the scaling factor (e.g., 2) from a respective input up-sampled feature. Each of a subset of down-sampling stages 602B-602D provides an intermediate down-sampled feature 610A, 610B, or 610C to a respective up-sampling stage 604D, 604C, or 604B via a respective skip connection. The intermediate down-sampled feature 610A, 610B, or 610C is combined with the intermediate up-sampled feature 612A, 612B, or 612C to generate a respective combined intermediate feature (e.g., on an element-by-element basis, by concatenation). Each combined intermediate feature is provided to a next up-sampling stage 604B, 604C, or 604D to generate the corresponding up-sampled feature 612B, 612A, or 612F. In an example, the up-sampled features 612C, 612B, 612A, and 612F generated by the decoding stages 604A-604D have resolutions of 68×68, 136×136, 272×272, and 544×544 elements, respectively. The up-sampled feature 612F outputted by the decoding network 604 is provided to the output network 608, and the output network 608 generates one or more output feature maps 614 (e.g., 614A and 614B) having a resolution of 544×544 elements. In some embodiments, the one or more output feature maps 614 correspond to the character score map 522, the affinity score map 524, or both, and indicate the character boxes 502, the affinity boxes 504, or both.

Alternatively, in some embodiments, the data processing model 240 includes an encoding network 602 including a series of down-sampling stages (e.g., 602A, 602B, 602C, 602D, and 602E), and does not include a series of up-sampling stages. Each of a subset of down-sampling stages 602B-602D provides an intermediate down-sampled feature 610A, 610B, or 610C to a respective up-sampling stages 604D, 604C, or 604B via a respective skip connection. The intermediate down-sampled feature 610A, 610B, or 610C is combined with an intermediate up-sampled feature 612A, 612B, or 612C to generate a combined intermediate feature (e.g., on an element-by-element basis, by concatenation). The combined intermediate feature is up-sampled by interpolation, e.g., without using neural networks that need to be trained. For example, each of the up-sampling modules 604A-604D is configured to implement an interpolation operation without using any neural network.

The data processing model 240 is trained by a plurality of training images 618 before it is used to process the input image 518. In some embodiments, ground truth labels are generated for a training image 618. The ground truth label of the training image 618 includes one or more of: a character score map 522GT, an affinity score map 524GT, and associated character boxes 502GT. Each score element 532 of the character score map 522GT represents the probability that the corresponding one or more pixels 538C are the center 506 of the respective character 500. Each affinity score element 534 of the affinity score map 524 represents the probability that the corresponding pixel 538C is the center 516 of the spacing 510 between two immediately adjacent characters 500. A probability distribution is simulated using Gaussian heatmaps having values between 0 and 1. Each training image 618 includes ground truth character boxes 502GT. The ground truth for both the character score map 522 and the affinity score map 524 are approximated and generated by one or more of: (1) preparing a 2D Gaussian map; (2) implementing a perspective transform between a respective Gaussian map region and each character box; (3) warping the respective 2D Gaussian map region to each character box. The ground truth character boxes 502GT of the characters 500GT in the training image 618 are identified, and the ground truth character score map 522GT is generated based on the ground truth character boxes 502GT using 2D Gaussian map regions that are concentric with the ground truth character boxes 502GT. In some embodiments, the centers 514 of the top and bottom triangles of two immediately adjacent character boxes 502GT are connected to form the ground truth affinity boxes 504GT.

During training, the data processing model 240 receives the training image 618 and generates one or more output feature maps 614, thereby identifying the character boxes 502 and 504 in the training image 618. The one or more output feature maps 614 are compared with the ground truth label including the character score map 522 or the affinity score map 524 to generate a loss function. The data processing model 240 is dynamically modified based on the loss function L. In an example, the loss function L applied to train the data processing model 240 is defined as follows:

$$L = {\sum }_{p} {\vert {X}_{r} ( p ) - {X}_{r}^{*} ( p ) \vert}_{2}^{2} + {\vert {X}_{a} ( p ) - {X}_{a}^{*} ( p ) \vert}_{2}^{2} \qquad ( 1 )$$

where p is one of a plurality of character boxes, Xᵣ(p) and Xᵣ*(p) are a first output feature map 614A and the ground truth character score map 522GT associated with the training image 618, and Xₐ(p) and Xₐ*(p) are a second output feature map 614B and the ground truth affinity score map 524GT associated with the training image 618.

Stated another way, in some embodiments, each ground truth character score map 522GT includes a plurality of 2D Gaussian map regions corresponding to a plurality of ground truth character boxes 502GT in a training image. A center 506 of each ground truth character box 502GT is associated with the peak probability value of a respective 2D Gaussian map region, and a middle point of an edge of the respective ground truth character box 502GT is associated with a characteristic portion (e.g., 50%, σ, 2σ, 3σ) of the peak probability value of the respective 2D Gaussian map region. Probability values in respective 2D Gaussian map region drop along a width direction and a height direction, and for example, drops by the characteristic portion of the peak probability value from the center 506 to the middle point of the edge of the respective ground truth character box 502GT. The output feature map(s) 614 of the data processing model 240 is compared with the ground truth character or affinity score maps 522GT or 524GT to generate the loss function L. The data processing model 240 is dynamically modified based on the loss function L.

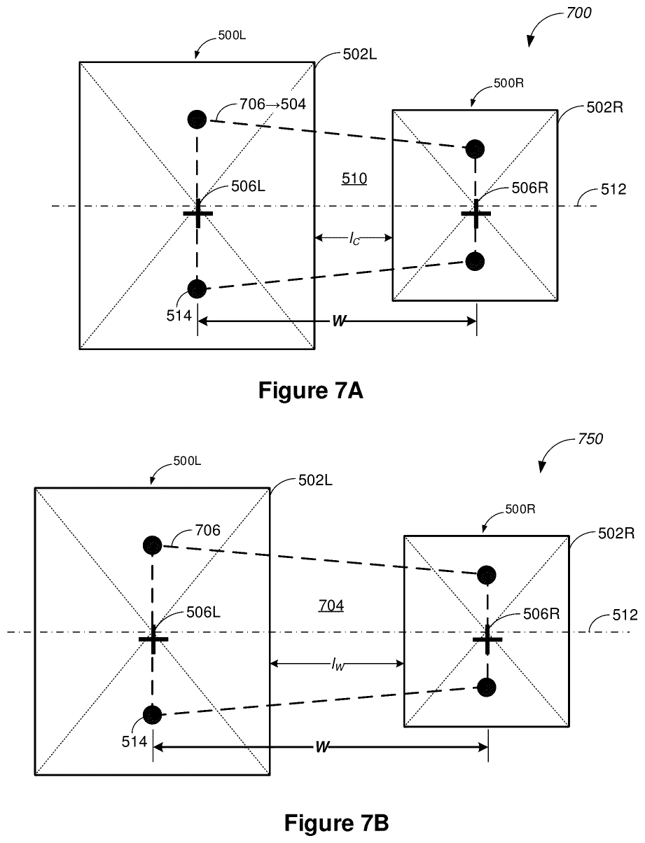

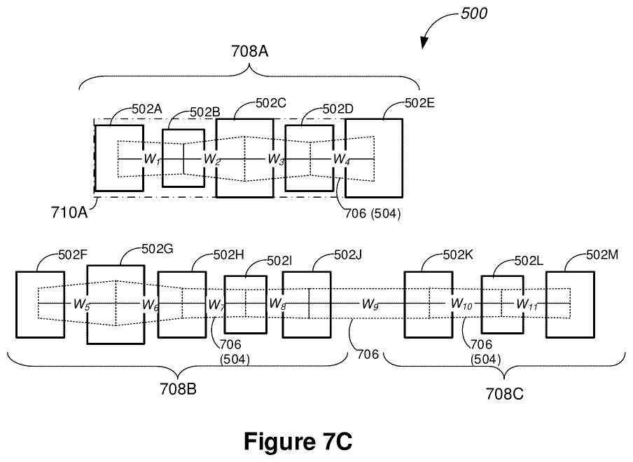

In some embodiments, during inference, word-level bounding boxes are created by merging the one or more output feature maps 614 and get borders of the word-level bounding boxes from the merged feature map 614. More details on generating a word-level bounding box are explained below with respect to FIG. 7C.

FIG. 7A illustrates two characters 500 that is separated by a character spacing 510 in a word 700, in accordance with some embodiments, and FIG. 7B illustrates two characters 500 that is separated by a word or sentence spacing 704 of two words 750, in accordance with some embodiments. A spacing separating two immediately adjacent characters 500 is optionally a character spacing 510 or a word or sentence spacing 704. The character spacing 510 has a first separation l_{C}, and the word or sentence spacing 704 has a second separation l_{W} greater than the first separation l_{C}. Referring to FIG. 7A, in some embodiments, for each pair of two immediately adjacent character boxes 502, a respective tentative box 706 is interpolated to connect two centers 506L and 506R of the two immediately adjacent character boxes 502. The respective tentative box has a width W substantially equal to a distance between the two centers 506L and 506R of the two immediately adjacent character boxes 502L and 502R. In accordance with a determination that the width of the respective tentative box W is less than a threshold width W_{TH}, the respective tentative box 504 is associated with a respective affinity box 504 representing a respective one of the plurality of spacings 510 separating the plurality of characters 500 in the input image 518.

Referring to FIG. 7B, in some embodiments, a respective tentative box 706 is interpolated to connect two centers 506L and 506R of the two immediately adjacent character boxes 502. The respective tentative box 706 has a width W equal to a distance between the two centers of the two immediately adjacent character boxes 502. In accordance with a determination that the width W of the respective tentative box 706 is equal to or greater than a threshold width W_{TH}, the respective tentative box 706 is associated with a respective word or sentence spacing 704 between two immediately adjacent words or sentences. The respective word or sentence spacing 704 is distinct from the plurality of spacings 510. Further, in some embodiments, the plurality of characters 500 in the input image 518 is grouped to two or more words based on the plurality of spacings 510 in accordance with a determination that the tentative box 706 is associated with a word or sentence spacing 704 and cannot be identified as one of the plurality of (character) spacings 510.

Stated another way, in some embodiments, only an affinity box 504 associated with a character spacing 510 is labeled on the input image 518. The tentative box 706 (FIG. 7A) narrower than the threshold width W_{TH} is identified as the character spacing 510, and is therefore, kept as one of the spacings 510 in the input image 518. In other words, when the width of the tentative box 706 is less than the threshold width W_{TH}, the space corresponding to such tentative box 706 is determined as the character spacing 510 which is labeled on the input image 518. Conversely, the tentative box 706 (FIG. 7B) wider than the threshold width W_{TH} is not identified as the character spacing 510, and therefore, deleted from the input image 518.

In some embodiments, the threshold width W_{TH} is determined based on a threshold separation I_{TH} that is greater than the first separation l_{C} of the two characters 500 of the word 700 and less than the second separation l_{W} of the two words 750. For example, the threshold width W_{TH} is determined as a sum of the threshold separation I_{TH} and a half of a total width of the character boxes 502L and 502R.

FIG. 7C is a set of characters 500A-502M that are grouped to three words 708A-708C, in accordance with some embodiments. A data processing model 240 is applied to recognize a plurality of character boxes 502A-502M (e.g., 13 boxes) in an input image 518. Four tentative boxes 706 are identified among a first row of five character boxes 502A-502E, and have widths W₁, W₂, W₃, and W₄, respectively. A respective width of each tentative boxes 706 is compared with, and determined to be smaller than, the threshold width W_{TH}. In accordance with a determination that the five character boxes 502A-502E are successively connected by the four tentative boxes 706 narrower than the threshold width W_{TH}, each tentative box 706 on the first row corresponding to a respective character spacing 510, and the five character boxes 502A-502E on the first row are determined to form a first word 708A, e.g., merged to form a first word bounding box 710A. Specifically, a subset of the five character boxes 502A-502E are stretched to make the five character boxes 502A-502E having the same height that is equal to or greater than the greatest height of the five character boxes 502A-502E, and adjacent edges of the five character boxes 502A-502E are expanded to fill the character spacings 510 separating the five character boxes 502A-502E. The stretched and expanded five character boxes 502A-502E are further merged to form the first word bounding box 710A.

Additionally, seven tentative boxes 706 are identified among a second row of eight character boxes 502, and have widths W₅, W₆, W₇, W₈, W₉, W₁₀, and W₁₁, respectively. A respective width of each tentative box 706 on the second row is compared with the threshold width W_{TH}. The widths W₅, W₆, W₇, W₈, W₁₀, and Win are determined to be smaller than the threshold width W_{TH}, while the width W₉ is greater than the threshold width W_{TH}. In accordance with a determination that five character boxes 502F-502J are successively connected by four tentative boxes 706, the left four tentative boxes 706 on the second row correspond to four character spacings 510, and the left five character boxes 502F-502J on the second row are determined to form a second word 708B, e.g., merged to form a second word bounding box (not shown). In accordance with a determination that three character boxes 502K-502M are successively connected by two tentative boxes 706, the right two tentative boxes 706 on the second row correspond to two character spacings 510, and the three character boxes 502K-502M on the second row are determined to form a third word 708C, e.g., merged to form a third word bounding box (not shown). Conversely, in accordance with a determination that the width W₉ is greater than the threshold width W_{TH}, the tentative box 706 does not correspond to a character spacing 510, and the character boxes 502J and 502K are not connected by an affinity box 504 or a character spacing 510.

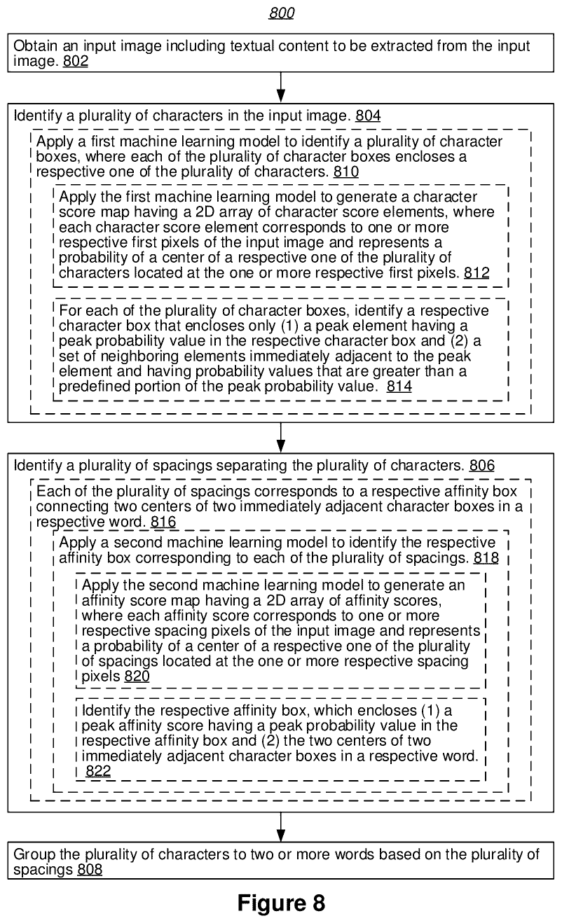

FIG. 8 is a flow diagram of an example text recognition method 800, in accordance with some embodiments. For convenience, the method 800 is implemented by at least an electronic device (e.g., a text recognition module 230 of a data processing module 228 of a mobile phone 104C). Method 800 is, optionally, governed by instructions that are stored in a non-transitory computer readable storage medium and that are executed by one or more processors of the computer system. Each of the operations shown in FIG. 8 may correspond to instructions stored in a computer memory or non-transitory computer readable storage medium (e.g., memory 206 in FIG. 2). The computer readable storage medium may include a magnetic or optical disk storage device, solid state storage devices such as Flash memory, or other non-volatile memory device or devices. The instructions stored on the computer readable storage medium may include one or more of: source code, assembly language code, object code, or other instruction format that is interpreted by one or more processors. Some operations in method 800 may be combined and/or the order of some operations may be changed.

The electronic device obtains (802) an input image 518 including textual content 520 (FIG. 5B) to be extracted from the input image 518 and identifies (804) a plurality of characters 500 in the input image 518. The electronic device identifies (806) a plurality of spacings 510 separating the plurality of characters 500. The plurality of characters 500 is grouped (808) to two or more words based on the plurality of spacings 510.

In some embodiments, the electronic device identifies the plurality of characters 500 in the input image 518 by applying (810) a first machine learning model to identify a plurality of character boxes 502, each of the plurality of character boxes 502 enclosing a respective one of the plurality of characters 500. Further, in some embodiments, the electronic device applies (812) the first machine learning model to generate a character score map 522 having a 2D array of character score elements 532. Each character score element 532 corresponds to one or more respective character pixels of the input image 518 and represents a probability of a center 506 of a respective one of the plurality of characters 500 located at the one or more respective character pixels. For each of the plurality of character boxes 502, the electronic device identifies (814) a respective character box 502 that encloses only (1) a peak element having a peak probability value in the respective character box and (2) a set of neighboring elements immediately adjacent to the peak element and having probability values that are greater than a predefined portion of the peak probability value.

Further, in some embodiments, the electronic device obtains a training image 618 (FIG. 6) and labels a plurality of ground truth character boxes 502GT in the training image 618. Each of the plurality of ground truth character boxes 502GT closely encloses a respective distinct ground truth character 500GT in the training image 618. The first machine learning model is trained based on the training image 618 and the plurality of ground truth character boxes 502GT. Additionally, in some embodiments, a ground truth character score map 522GT is generated by associating a center 506 of each ground truth character box 502GT with a peak probability value (e.g., equal to 1) of the ground truth character score map 522GT and a middle point of an edge of the respective ground truth character box 502GT with a predefined portion (e.g., 0.5, 1-o) of the peak probability value of the ground truth character score map 522GT. Probability values drop along a width direction and a height direction, from the center to the middle point of the edge of the respective training character box 502GT, e.g., based on a 2D Gaussian distribution. The first machine learning model is applied to generate an output feature map 614 from the training image 618 and identify a plurality of training character boxes 502. A loss function L is generated by comparing the output feature map 614 and the ground truth character score map 522GT. The first machine learning model dynamically modified based on the loss function L.

In some embodiments, the first machine learning model is trained on the electronic device and applied to process the input image 518 locally on the electronic device. Alternatively, in some embodiments, the first machine learning model is trained on the server 102 and deployed to the electronic device, such that the first machine learning model is applied to process the input image 518 on the electronic device.

In some embodiments, the first machine learning model includes an encoding network 602 and a decoding network 604 coupled to the encoding network 602. The encoding network 602 includes a series of down-sampling stages, and the decoding network 604 includes a series of up-sampling stages. Further, in some embodiments, the electronic device provides, by each of a subset of down-sampling stages, an intermediate down-sampled feature 610 to the decoding network 604 via a respective skip connection, combines the intermediate down-sampled feature 610 and an intermediate up-sampled feature 612 to generate a combined intermediate feature, and up-samples the combined intermediate feature by a respective up-sampling stage.

In some embodiments, the first machine learning model includes an encoding network 602, the encoding network including a series of down-sampling stages (e.g., 602A-60E). The first machine learning model is applied by providing, by each of a subset of down-sampling stages (e.g., 602B-602D), an intermediate down-sampled feature (e.g., 610A-610C) to a respective up-sampling module (e.g., 604D, 604C, and 604B) via a respective skip connection. The electronic device combines the intermediate down-sampled feature (e.g., 610A, 610B, or 610C) and an intermediate up-sampled feature (e.g., 612A, 612B, or 612C) to generate a combined intermediate feature and up-samples the combined intermediate feature by interpolation.

In some embodiments, each of the plurality of spacings 510 corresponds (816) to a respective affinity box 504 (FIG. 5A) connecting two centers 506L and 506R of two immediately adjacent character boxes 502 in a respective word. Further, in some embodiments, the electronic device identifies the plurality of spacings 510 by applying (818) a second machine learning model to identify the respective affinity box 504 corresponding to each of the plurality of spacings 510. In some embodiments, the first machine learning model includes the second machine learning model. The same machine learning model is applied to generate the character boxes 502 and the affinity boxes 504. Additionally, in some embodiments, the electronic device applies (820) the second machine learning model to generate an affinity score map 524 having a 2D array of affinity scores 534. Each affinity score 534 corresponds to one or more respective spacing pixels 538S of the input image 518 and represents a probability of a center 516 of a respective one of the plurality of spacings 510 located at the one or more respective spacing pixels 538S. The electronic device identifies (822) the respective affinity box 504 corresponding to each spacing 510. The respective affinity box 504 encloses (1) a peak affinity score having a peak probability value in the respective affinity box 504 and (2) the two centers 506L and 506R of two immediately adjacent character boxes 502 in a respective word.

In some embodiments, the electronic device interpolates a respective tentative box 706 (FIGS. 7A and 7B) connecting two centers 506L and 506R of the two immediately adjacent character boxes 502. The respective tentative box 706 has a width W equal to a distance between the two centers 506L and 506R of the two immediately adjacent character boxes 502. In accordance with a determination that the width W of the respective tentative box 706 is less than a threshold width Wr, the electronic device associates the respective tentative box with a respective affinity box 504 representing a respective one of the plurality of spacings 510 among the plurality of characters 500 in the input image 518.

In some embodiments, for each pair of two immediately adjacent character boxes 502, the electronic device interpolates a respective tentative box 706 (FIG. 7B) connecting two centers 506L and 506R of the two immediately adjacent character boxes 502, and the respective tentative box 706 has a width W equal to a distance between the two centers 506L and 506R of the two immediately adjacent character boxes 502. In accordance with a determination that the width of the respective tentative box 706 is equal to or greater than a threshold width W_{TH}, the electronic device associates the respective tentative box 706 with a respective word separation between two immediately adjacent words of the two or more words. The respective word separation is distinct from the plurality of spacings 510.

It should be understood that the particular order in which the operations in FIG. 8 have been described are merely exemplary and are not intended to indicate that the described order is the only order in which the operations could be performed. One of ordinary skill in the art would recognize various ways to recognize textual content 520 in an image. Additionally, it should be noted that details of other processes described above with respect to FIGS. 1-6 are also applicable in an analogous manner to method 800 described above with respect to FIG. 8. For brevity, these details are not repeated here.

The terminology used in the description of the various described implementations herein is for the purpose of describing particular implementations only and is not intended to be limiting. As used in the description of the various described implementations and the appended claims, the singular forms “a”, “an” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof. Additionally, it will be understood that, although the terms “first,” “second,” etc. may be used herein to describe various elements, these elements should not be limited by these terms. These terms are only used to distinguish one element from another.

As used herein, the term “if” is, optionally, construed to mean “when” or “upon” or “in response to determining” or “in response to detecting” or “in accordance with a determination that,” depending on the context. Similarly, the phrase “if it is determined” or “if [a stated condition or event] is detected” is, optionally, construed to mean “upon determining” or “in response to determining” or “upon detecting [the stated condition or event]” or “in response to detecting [the stated condition or event]” or “in accordance with a determination that [a stated condition or event] is detected,” depending on the context. It is notable that the term “a plurality of” and “multiple” in the disclosure means two or more.

The foregoing description, for purpose of explanation, has been described with reference to specific embodiments. However, the illustrative discussions above are not intended to be exhaustive or to limit the claims to the precise forms disclosed. Many modifications and variations are possible in view of the above teachings. The embodiments were chosen and described in order to best explain principles of operation and practical applications, to thereby enable others skilled in the art.

Although various drawings illustrate a number of logical stages in a particular order, stages that are not order dependent may be reordered and other stages may be combined or broken out. While some reordering or other groupings are specifically mentioned, others will be obvious to those of ordinary skill in the art, so the ordering and groupings presented herein are not an exhaustive list of alternatives. Moreover, it should be recognized that the stages can be implemented in hardware, firmware, software or any combination thereof.

1. A text recognition method, implemented at an electronic device, comprising:
obtaining an input image including textual content to be extracted from the input image;
identifying a plurality of characters in the input image; and
identifying a plurality of spacings separating the plurality of characters; and
grouping the plurality of characters to two or more words based on the plurality of spacings.

2. The method of claim 1, wherein identifying the plurality of characters in the input image comprises:
identifying, by applying a first machine learning model, a plurality of character boxes, each of the plurality of character boxes enclosing a respective one of the plurality of characters.

3. The method of claim 2, wherein identifying, by applying the first machine learning model, the plurality of character boxes comprises:
generating, by applying the first machine learning model, a character score map having a two-dimensional (2D) array of character score elements, each character score element corresponding to one or more respective character pixels of the input image and representing a probability of a center of a respective one of the plurality of characters located at the one or more respective character pixels; and
based on the character score map, identifying, as one of the plurality of character boxes, each character box that encloses only a peak element having a peak probability value in the respective character box and a set of neighboring elements immediately adjacent to the peak element and having probability values that are greater than a predefined portion of the peak probability value.

4. The method of claim 2, further comprising:
obtaining a training image;
labeling a plurality of ground truth character boxes in the training image, each of the plurality of ground truth character boxes closely enclosing a respective distinct ground truth character in the training image; and
obtaining the first machine learning model through training based on the training image and the plurality of ground truth character boxes.

5. The method of claim 4, further comprising:
generating a ground truth character score map, including
associating a center of each ground truth character box with a peak probability value of the ground truth character score map; and
associating a middle point of an edge of the respective ground truth character box with a predefined portion of the peak probability value of the ground truth character score map, wherein probability values drop along a width direction and a height direction, from the center to the middle point of the edge of the respective training character box;
generating an output feature map from the training image and identifying a plurality of training character boxes, by applying the first machine learning model;
generating a loss function by comparing the output feature map and the ground truth character score map; and
dynamically modifying the first machine learning model based on the loss function.

6. The method of claim 2, wherein the first machine learning model includes an encoding network and a decoding network coupled to the encoding network, the encoding network including a series of down-sampling stages, and the decoding network including a series of up-sampling stages.

7. The method of claim 6, wherein applying the first machine learning model comprises:
providing, by each of a subset of down-sampling stages, an intermediate down-sampled feature to a subset of up-sampling stages of the decoding network via a respective skip connection;
generating a combined intermediate feature by combining the intermediate down-sampled feature and an intermediate up-sampled feature, wherein the intermediate up-sampled feature is obtained by each of the subset of up-sampling stages from its previous up-sampling stage; and
up-sampling the combined intermediate feature by a respective up-sampling stage.

8. The method of claim 2, wherein:
the first machine learning model comprises an encoding network, the encoding network including a series of down-sampling stages;
applying the first machine learning model comprises providing, by each of a subset of down-sampling stages, an intermediate down-sampled feature to a respective up-sampling module via a respective skip connection; and
the method further comprises:
for at least one up-sampling module, generating a combined intermediate feature by combining the intermediate down-sampled feature and an intermediate up-sampled feature; and
up-sampling the combined intermediate feature by interpolation without using a neural network.

9. The method of claim 2, wherein each of the plurality of spacings corresponds to a respective affinity box connecting two centers of two immediately adjacent character boxes in a respective word.

10. The method of claim 9, wherein identifying the plurality of spacings comprises identifying, by applying a second machine learning model, the respective affinity box corresponding to each of the plurality of spacings.

11. The method of claim 10, wherein identifying, by applying the second machine learning model, the respective affinity box corresponding to each of the plurality of spacings comprises:
generating, by applying the second machine learning model, an affinity score map having a 2D array of affinity scores, each affinity score corresponding to one or more respective spacing pixels of the input image and representing a probability of a center of a respective one of the plurality of spacings located at the one or more respective spacing pixels; and
based on the affinity score map, identifying the respective affinity box, which encloses a peak affinity score having a peak probability value in the respective affinity box and the two centers of two immediately adjacent character boxes in a respective word.

12. The method of claim 2, wherein identifying the plurality of spacings comprises, for each pair of two immediately adjacent character boxes:
defining a respective tentative box connecting two centers of the two immediately adjacent character boxes, the respective tentative box having a width equal to a distance between the two centers of the two immediately adjacent character boxes; and
in accordance with a determination that the width of the respective tentative box is less than a threshold width, associating the respective tentative box with an affinity box representing a respective one of the plurality of spacings among the plurality of characters in the input image.

13. The method of claim 12, wherein the method further comprises:
in accordance with a determination that the width of the respective tentative box is equal to or greater than the threshold width, associating the respective tentative box with a respective word separation between two immediately adjacent words of the two or more words, the respective word separation distinct from the plurality of spacings.

14. An electronic device, comprising:
one or more processors; and
memory having instructions stored thereon, which when executed by the one or more processors cause the processors to perform a text recognition method comprising:
identifying a plurality of characters from an input image, the input image including to-be-extracted textual content;
identifying a plurality of spacings separating the plurality of characters in the input image; and
grouping the plurality of characters to two or more words based on the plurality of spacings.

15. A non-transitory computer-readable medium, having instructions stored thereon, which when executed by one or more processors cause the one or more processors to perform a text recognition method comprising:
obtaining an input image including to-be-extracted textual content;
identifying a plurality of characters in the input image;
identifying a plurality of spacings separating the plurality of characters in the input image; and
obtaining two or more words by grouping the plurality of characters based on the plurality of spacings.

16. The method of claim 9, wherein identifying the plurality of spacings comprises:
identifying, by applying the first machine learning model, the respective affinity box corresponding to each of the plurality of spacings.

17. The electronic device of claim 14, wherein identifying the plurality of characters in the input image comprises:
generating, by applying a first machine learning model, a character score map having a two-dimensional (2D) array of character score elements, each character score element corresponding to one or more respective character pixels of the input image and representing a probability of a center of a respective one of the plurality of characters located at the one or more respective character pixels; and
based on the character score map, identifying, as one of the plurality of character boxes, each character box that encloses only a peak element having a peak probability value in the respective character box and a set of neighboring elements immediately adjacent to the peak element and having probability values that are greater than a predefined portion of the peak probability value.

18. The electronic device of claim 17, wherein each of the plurality of spacings corresponds to a respective affinity box connecting two centers of two immediately adjacent character boxes in a respective word; and
wherein identifying the plurality of spacings comprises
identifying, by applying a second machine learning model, the respective affinity box corresponding to each of the plurality of spacings.

19. The electronic device of claim 18, wherein identifying, by applying a second machine learning model, the respective affinity box corresponding to each of the plurality of spacings comprises:
generating, by applying the second machine learning model, an affinity score map having a 2D array of affinity scores, each affinity score corresponding to one or more respective spacing pixels of the input image and representing a probability of a center of a respective one of the plurality of spacings located at the one or more respective spacing pixels; and
based on the affinity score map, identifying the respective affinity box, which encloses a peak affinity score having a peak probability value in the respective affinity box and the two centers of two immediately adjacent character boxes in a respective word.

20. The electronic device of claim 17, wherein identifying the plurality of spacings comprises, for each pair of two immediately adjacent character boxes:
defining a respective tentative box connecting two centers of the two immediately adjacent character boxes, the respective tentative box having a width equal to a distance between the two centers of the two immediately adjacent character boxes; and
in accordance with a determination that the width of the respective tentative box is less than a threshold width, associating the respective tentative box with an affinity box representing a respective one of the plurality of spacings among the plurality of characters in the input image; and
in accordance with a determination that the width of the respective tentative box is equal to or greater than the threshold width, associating the respective tentative box with a respective word separation between two immediately adjacent words of the two or more words, the respective word separation distinct from the plurality of spacings.
